(19) United States
(12) Patent Application Publication
(10) Pub. No.: US 2026/0045735 A1
(43) Pub. Date: Feb. 12, 2026

(54) HIGH SPEED DATA CABLE WITH SHIELDED STRAIN RELIEF AND METHOD OF PRODUCING SAME

(71) Applicant: Aptiv Technologies AG, Schaffhausen (CH)

(72) Inventors: Gert DROESBEKE, Erkrath (DE); Manoharan SRINIVASAN, Ennore (IN)

(21) Appl. No.: 19/276,248

(22) Filed: Jul. 22, 2025

(30) Foreign Application Priority Data
Aug. 7, 2024 (EP) 24193310.0

(51) Int. Cl. H01R 13/59; H01R 4/2495; H01R 13/58; H01R 13/6593

(52) U.S. Cl. CPC H01R 13/59; H01R 4/2495; H01R 13/5808; H01R 13/6593

(57) ABSTRACT

This disclosure relates to a cable with shielded cable strain relief including at least one conductor having a separate insulation jacket, a braided shielding layer disposed around the insulation jacket, and an outer jacket. The shielded cable strain relief incorporates an inner ferrule including a first inner crimping member. At a cable end, the outer jacket is removed over a length to enable connection of the cable to a connector assembly. The first inner crimping member is crimped on and in direct contact with the braided shielding layer at the cable end adjacent the outer jacket termination. The braided shielding layer is folded back over the inner ferrule and at least a portion of the outer jacket.

### CROSS-REFERENCE TO RELATED APPLICATION

This application claims the benefit of and priority to European Application No. 24193310.0 filed with the European Patent Office on Aug. 7, 2024, the contents of which are incorporated by reference herein.

### TECHNICAL FIELD

The present disclosure relates to a cable with shielded strain relief, the cable including at least one insulated conductor, a braided shielding layer and an outer jacket, and the strain relief including an inner ferrule. In particular, the cable with shielded strain relief is designed for high-speed data transfer.

### BACKGROUND

High-speed data transfer cables with connector assemblies are important in various electronic devices and communication systems inside vehicles, where reliable and efficient data transmission is necessary.

A weak point of such cables with connector assemblies is the connection between the cable and the connector assembly. Generally, at the connection the shielding properties are diminished and the complexity for a properly shielded connection is high.

In view of the foregoing, there is a need for an improved connection which improves the shielding properties, and which is easy to produce. It is therefore an object of the present disclosure to overcome some or all the deficiencies of the prior art, and to propose a cable with shielded cable strain relief that provides for a good shielding and is affordable.

### SUMMARY

The above-mentioned objectives are at least partially realized by a cable with shielded strain relief or by a method of producing a cable described below. Preferred embodiments are the subject of the dependent claims, and the skilled person will find clues to other suitable aspects of the present disclosure in the overall disclosure of the present application.

An aspect of the disclosure relates to a cable with shielded cable strain relief, where the cable includes at least one conductor, each conductor having a separate insulation jacket, a braided shielding layer disposed around the insulation jacket(s) of the conductor(s) and an outer jacket. The shielded cable strain relief includes an inner ferrule, which includes a first crimping member. The outer jacket is removed over a length at a cable end to allow the connection of the cable to a connector assembly. Where the outer jacket is removed, the braided shielding layer of the cable lying underneath is exposed. The first crimping member is crimped on and in direct contact with the braided shielding layer at the cable end adjacent to where the outer jacket ends. The first crimping member may thereby be crimped on a non-circular section of the cable by fixing the braided shielding layer on the insulated conductor(s). The braided shielding layer is securely held in place even when the cable is subjected to major pulling forces. In particular, the first crimping member makes sure that no gap between the shielding and the connector assembly is created when the cable is tensioned.

Furthermore, the braided shielding layer is folded backwards over the inner ferrule and at least a portion of the outer jacket. By folding back the braided shielding layer, a braided shielding layer length of up to 12.5 mm can be absorbed without requiring an additional cut back of the shielding layer. This way, the complexity during production is reduced and risks of wrongly cutting the shielding layer at the cable end are minimized. Additionally, the conductive path of the folded braided shielding layer is ideal for the ground return current, such as delta or plus versus minus signal and/or in current converted EM attack, because it is as close as possible to the signal lines and without detours.

Such cable with shielded strain relief can perform reliably with speeds up to 10 GHZ.

The strain relief may further include an outer ferrule configured to be in contact with and to at least partially covering the folded braided shielding layer. The outer ferrule thereby secures the braided shielding layer and adds an additional strain relief location where the cable is protected against stripping under tension.

The outer ferrule may for example be a tube which is pre-assembled over the cable outer jacket. In a preferred embodiment however, the outer ferrule may include at least one outer crimping member in form of a pair of overlapping outer crimping wings. The crimping wings have the advantage of closing gaps in the shielding by electromagnetic compliance (EMC) labyrinths.

Advantageously the overlap is further dimensioned to prevent loose wires of the braided shielding layer to protrude from the outer ferrule, at the seam. This will enhance shielding effectiveness, physical damage protection, reduces safety risks and increases signal integrity.

In one preferred embodiment, the first crimping member encircles the at least one conductor(s) and includes at least one embossment protruding inwards. The first crimping member may also have two 2 inner embossments, 3 inner embossments or even more preferably 4 inner embossments. As each embossment is designed and dimensioned to increase the contact area between the first crimping member and the braided shielding layer, with each embossment the contact area is increased.

The embossed, first inner crimping member is advantageously essentially a ring, and the at least one embossment is preferably formed by two parallel cuts in the ring and by inwardly pushing the portion of the ring between the cuts. The cuts are made in radial direction and when the material between the cuts is depressed, the outer ring shape remains. This way, while the first inner crimping member can be crimped onto an essentially oval inner shape, the outer shape is round. This generally lowers the complexity and costs of the assembly as it can for example facilitate the crimping of the outer ferrule on the round shape, while having an oval inner shape.

The inner ferrule can further include a second crimping member crimped on and in contact with the outer jacket of the cable at the cable end where the outer jacket ends. With this additional strain relief location, any pull or stretch force on the cable is better distributed, such that the cable strain relief performance of the inner ferrule is further enhanced.

Advantageously, the first inner crimping member is connected to the second inner crimping member to secure the inner crimping members against sliding with respect to one another. This also improves the cable strain relief performance of the inner ferrule as a whole.

The outer ferrule and/or the inner ferrule can be made of sheet metal. In particular, they can be stamped and formed out of sheet metal. This is an easy and cost-effective way of producing ferrules. Such ferrules do not need complicated equipment for the production, nor do they need to be bought from specialized producers, like die-cast items. In particular, when the ferrules include crimping wings, they also do not need to be pre-mounted, but they can be crimped on the cable, which additionally simplifies the production and lowers the costs.

In embodiments in which the cable includes two conductors, and in which the braided shielding layer encloses both of the conductors with their respective insulation jackets, the braided shielding layer has typically an oval shape. To ensure an effective shielding, the braided shielding layer should be as close as possible to the signal lines. The first crimping member ensures that the braided shielding layer remains as close as possible to the conductors. To crimp it onto the narrow and non-circular section of the inner of the cable, namely the conductors with insulation jacket and braided shielding layer, the first crimping member can have crimping wings that can optionally overlap at the seam line, or the first crimping member can be ring-shaped with embossments ensuring proper contact.

To produce the cable with a shielded cable strain relief in a first step the outer jacket of a cable is rotatory stripped at a cable end, leaving the length of the cable without outer jacket. Secondly, the first inner crimping member of the inner ferule is crimped on and in direct contact with a braided shielding layer of the cable on the cable end, next to the end of the outer jacket. Once the braided shielding layer is secured to the inner of the cable, the end of the braided shielding layer is widened and folded backwards over the inner ferrule. This enables absorbing enough length of the braided shielding layer so that it is not necessary to trim to length. The folded shielding layer does not translate to a significant increase in the terminal packaging size.

Additionally, the production method may further include the step of crimping the outer ferrule over the inner ferrule and the folded braided shielding layer. The outer ferrule then is advantageously in direct contact with the shielding layer. To hinder the wires of the shielding layer to stick out, first outer crimping wings can be closed in overlap over the braided shielding layer. Additionally, the overlap ensures that there are no EMC gaps. Having crimped outer crimping wings also provides for an all-around 360° degrees strain relief and results in an ideal conductive path for the ground return current.

To secure the braided shielding layer in the inner of the cable, a second inner crimping member of the inner ferrule can be crimped onto the outer jacket of the cable. To secure the braided shielding layer first inner crimping wings of the first inner crimping member can also be crimped on the braided shielding layer, or the first inner crimping member can be embossed to create at least one embossment protruding in direction of the inner of the cable.

### BRIEF DESCRIPTION OF THE DRAWINGS

In the following, preferred embodiments of the disclosure are disclosed by reference to the accompanying figures.

FIG. 1 shows a cross-section side view of a first embodiment of the cable with shielded strain relief together with a 90° connector assembly according to some embodiments.

FIG. 2 shows an isometric cross-section view of a cable with shielded strain relief according to some embodiments.

FIGS. 3a, 3b, and 3c show a cross-section view of the inner ferrule with a varying number of embossments around the oval-shaped shielding layer of the cable according to some embodiments.

FIG. 4 shows an isometric view of the inner ferrule of FIG. 3a without the braided shielding layer according to some embodiments.

FIGS. 5a to 5d show the inner ferrule on a cable end according to some embodiments.

FIGS. 6a to 6d show a crimp connection of an outer ferrule with overlapping crimping wings according to some embodiments.

### DETAILED DESCRIPTION

In the following, preferred embodiments of the present disclosure are described in detail with respect to the figures.

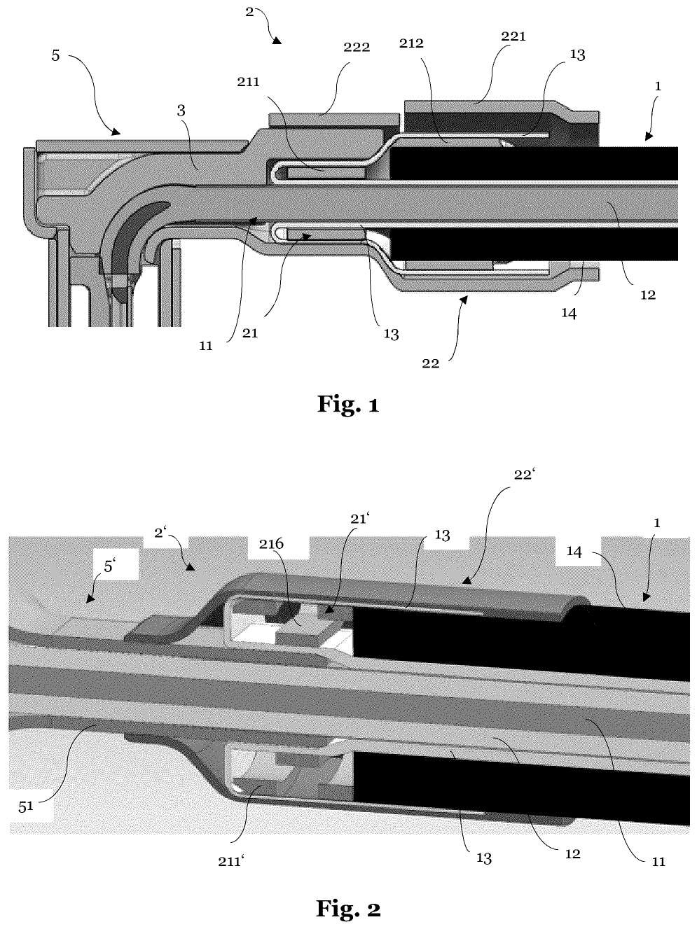

FIG. 1 shows a cross-section side view of a cable 1 with shielded cable strain relief 2 according to a first preferred embodiment. Therein, a cable 1 includes an outer jacket 14 which is stripped from the cable 1 at a cable end (left in the figure). The cable includes a braided shielding layer 13, that is disposed around, and thus surrounds and encloses, an inner conductor arrangement including a conductor 11, that is provided with an insulation jacket 12. Thus, the shielding layer 13 is arranged between the outer jacket 14 and the insulation jacket 12 of the conductor 11.

An inner ferrule 21 is provided to improve shielding continuity and strain relief to the cable 1. The inner ferrule 21 includes a first inner crimping member 211 and a second inner crimping member 212 that may be connected with each other. The inner crimping member 211 is crimped onto the braided shielding layer 13 at the portion, where the outer jacket 14 is removed from cable 1. The second inner crimping member 212 of the inner ferrule 21 is crimped onto the outer jacket 14.

The braided shielding layer 13 is folded back over the first inner crimping member 211 of the inner ferrule 21 by 180° and guided back over the second inner crimping member 212 and a portion of the outer jacket 5. The second inner crimping member 212 is arranged between the outer jacket 5 and the backwards bend shielding layer 13.

To improve the strain relief performance even further the shown embodiment includes an outer ferrule 22 including a first outer crimping member 221 and a second outer crimping member 222. The outer ferrule 22 is configured to be in contact with and to at least partially cover the folded shielding layer 13. As one see in FIG. 1, the outer ferrule 22 is also at least partially in direct contact with the folded-back shielding layer 13 to improve shielding continuity and enhance mechanical stability of the assembly.

To improving the strain relief performance, the outer ferrule 22 is designed to make sure that no wires of the braided shielding layer 13 stick out from the crimp connection. As shown in FIG. 1, the first outer crimping member 221 covers the end of the backfolded braided shielding layer 13 to enclose all potentially loose wires. The second outer crimping member 222 is at least partially crimped over an insert 3 of a connector assembly 5. The insert 3 also functions as part of the strain relief when covered by the second crimping member 222 as the insert 3 is pushed onto the insulation jacket 12 of the conductor 11 of the cable 1.

FIG. 2 shows an isometric cross-section side view of a second embodiment of the cable 1 with shielded strain relief 2′. This embodiment differs from the embodiment of FIG. 1 mainly in the design of the inner and outer ferrules. In FIG. 2 one can see the composition of the cable 1, including the outer jacket 14 and the conductor 11, having a separate insulation jacket 12. The shielding layer 13 is disposed around the insulation jacket 12. In the shown embodiment, the cable 1 includes two conductors 11, each having its own (separate) insulation jacket 12. Due to the perspective of FIG. 2, only one of the conductors is visible. The shielding layer 13 does enclose both conductors 11. The cable 1 is connected to a connector assembly 5′ that is only partially shown. The connector assembly 5′ includes an outer wall 51 that is attached to the end of cable 1.

In the second embodiment an inner ferrule 21′ is crimped onto the shielding layer 13, as in the first embodiment. However, in the second embodiment a part of the outer wall 51 is arranged between the insulation jacket 12 and the shielding layer 13 to improve shielding continuity. The inner ferrule 21′ is crimped onto the braided shielding layer 13 by means of first inner crimping member 211′ including embossments 216. In contrast to the first embodiment, the shown inner ferrule 21′ does not have a second inner crimping member 212 crimped on the outer jacket. As with the first embodiment, the shielding layer 13 is bend backwards by 180° over the inner ferrule 21′ and the outer jacket 14.

The connector assembly shown in FIG. 2 is a straight connector assembly whereas the connector assembly shown in FIG. 1 is a 90° connector assembly. The outer ferrule 22′ shown in the second embodiment of FIG. 2 is a tube which is pre-assembled over and crimped on the inner ferrule 21′ and the outer jacket 14 of cable 1. To evenly distribute the crimping force the inner ferrule 21′ has advantageously the same outer diameter as the outer jacket 14 of the cable 1.

The skilled person will understand that technical details of the differences can be interchanged between the embodiments of FIG. 1 and FIG. 2.

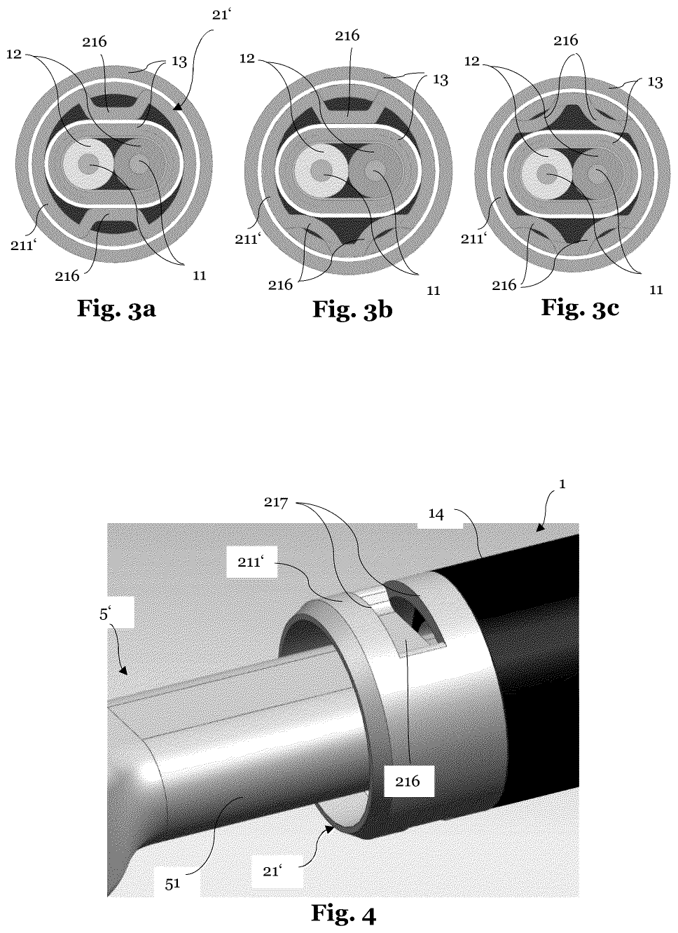

FIGS. 3a to 3c show cross-sections of variations of the inner ferrule 21′. The variation lies in the number and arrangement of the embossments 216. As mentioned above, the cable 1 of FIG. 2 includes a pair of conductors 11, which are visible in the views of FIGS. 3a to 3c. Each conductor 11 has its own separate insulation jacket 12. The shielding layer 13 is disposed around the insulation jackets 12, thus encircling both conductors. This results in an oval shape. The shielding layer 13 is bent backwards by 180° over the inner ferrule 21′, so that in the cross-section views of FIGS. 3a to 3c it appears twice, having an oval shaped configuration arranged around the conductors, and a circle shaped configuration around the inner ferrule 21′. This change in configuration is possible due to the flexibility of braided shielding layers.

The first inner crimping member 211′ of the inner ferrule 21′ has two embossments 216 to secure the inner ferrule 21′ around the conductors 11. In cross-section, the oval shape of the conductors with the braided shielding layer is clearly visible. As the base configuration of the inner ferrule is circular, there would be only two contact areas with the oval shape of the shielding layer 13 enclosing the two conductors 11, namely on the left- and right-hand side. Due to the two embossments 216, in the embodiment of FIG. 3a, there are now four contact areas.

Depending on the size of the inner ferrule 21′ and the cable 1, and on the desired shielding properties, the inner crimping member 211′ may have one, two (FIG. 3a), three (FIG. 3b), four (FIG. 3c), or more embossments. As one see in FIG. 3b, this configuration has essentially five contact areas and the variant of FIG. 3c has six contact areas. Thus, the embossments increase and thus improve the mechanical and electrical contact between the inner ferrule and the shielding layer 13.

FIG. 4 shows an isometric view of the inner ferrule 21′ of FIG. 2 and FIG. 3a. For a better understanding, the braided shielding layer 13 is not shown in FIG. 4. The inner ferrule 21′, respectively the first inner crimping member 211′, is made from a metal ring. The two embossments 216 are created by making two parallel cuts 217 on opposing sides of the ring and by pushing the portion of material between the two cuts inwards.

It is further visible in FIG. 4 that the outer dimension of the inner ferrule 21′ matches the outer dimension of the cable. As explained above, this has the advantage of evenly distributing crimping forces when an outer ferrule 22′ is crimped over the inner ferrule 21′ and the outer jacket 14 of the cable. FIG. 4 further shows the end of a straight connector assembly 5′ to which the cable is connected.

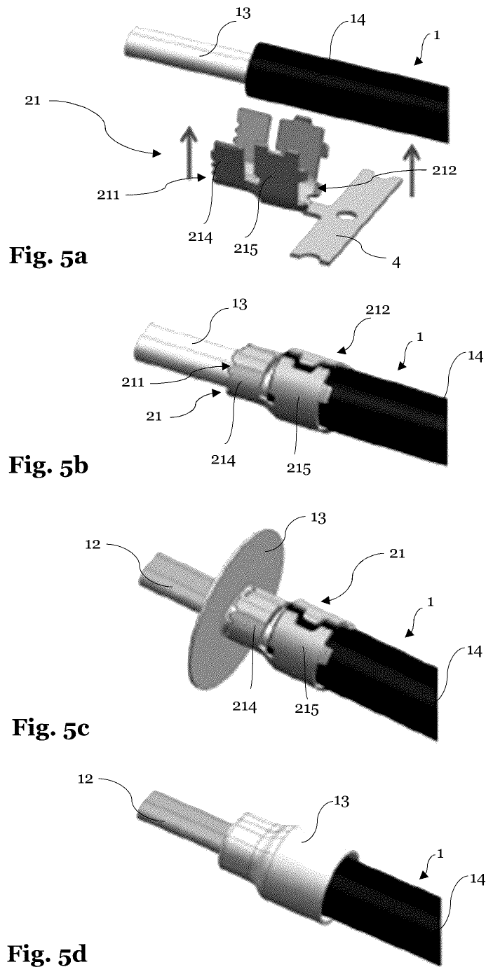

FIGS. 5a to 5d show some of the production steps of the first embodiment shown in FIG. 1. In particular, FIG. 5a shows the inner ferrule 21 made of stamped and bent sheet metal. The inner ferrule 21 is produced with a mounting aid 4 which is removed in subsequent production steps. The inner ferrule 21 has the first inner crimping member 211 with first inner crimping wings 214 and the second inner crimping member 212 with second inner crimping wings 215, whereby the first and second crimping members 211 and 212 are connected to each other. The outer jacket 14 of cable 1 is partially removed exposing the braided shielding layer 13. The first inner crimping member 211 is mounted on the exposed braided shielding layer 13 and the second inner crimping member 212 is mounted on the outer jacket 14.

FIG. 5b shows the inner ferrule with the first inner crimping wings 214 crimped onto the braided shielding layer 13 and the second inner crimping wings 215 crimped onto the outer jacket 14 of the cable 1.

In FIG. 5c, the braided shielding layer 13 is folded backwards exposing the underlying insulation jacket 12 of the conductor. As one can see in FIG. 5d, the shielding layer 13 is widened at its end and subsequently backfolded over the first inner crimping member 211 and the second inner crimping member 212 and thereby also over a portion of the outer jacket 14, since the second crimping member is arranged on the outer jacket.

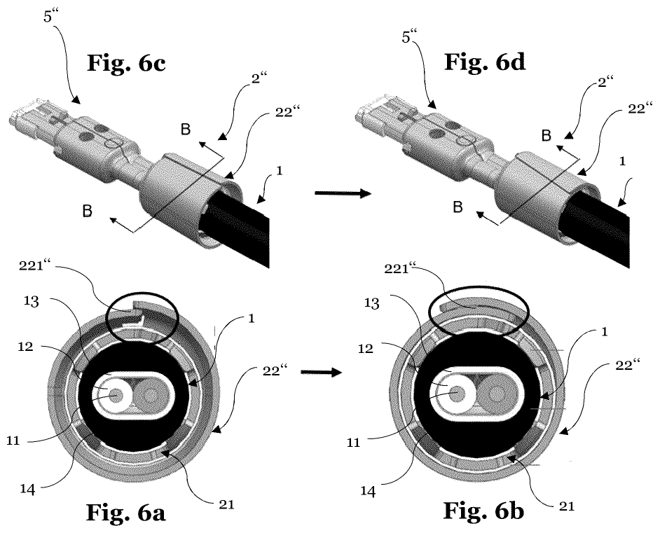

FIGS. 6a to 6d show a crimp connection of an outer ferrule 22″ with overlapping crimping wings. FIG. 6a shows a cable 1 with shielded cable strain relief 2 being connected to a connector 5″ before crimping. In the illustration of FIG. 6b, the crimping process is completed. FIGS. 6c and 6d show an isometric view and FIGS. 6a and 6b show cross section views along the line B-B in FIGS. 6a and 6b.

As can be seen in FIG. 6a, an outer ferrule 22″ including a first outer crimping member 221″ having two crimping wings is arranged around the end of a cable 1. As with the other embodiments, the outer jacket 14 of the cable is removed over a length to allow the connection of the cable to the connector assembly 5″. The shown embodiment also includes an inner ferrule 21 like the inner ferrule of the first embodiment. The crimping wings of the outer crimping member 221″ slightly overlap to guide and facilitate the actual crimping process.

In the illustrations of FIG. 6b, the crimping process is completed. As one can take in particular from the cross-section view of FIG. 6b, the first outer crimping member 221″ is fully crimped and the crimping wings overlap to an extent off approximately 20°. Thus, the overlap is dimensioned to prevent loose wires of the braided shielding layer 13 to stick out from the outer ferrule 22″.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LISTING OF REFERENCE NUMBERS

1 cable
11 conductors
12 insulation jacket of conductors
13 braided shielding layer
14 outer jacket
2, 2′, 2″ shielded cable strain relief
21, 21′ inner ferrule
211, 211′ first inner crimping member
212 second inner crimping member
214 first inner crimping wings
215 second inner crimping wings
216 embossments
217 cuts
22, 22′, 22″ outer ferrule
221, 221′, 221″ first outer crimping member
222 second outer crimping member
3 insert
4 mounting aid
5,5′,5″ connector assembly
51 wall of connector assembly

1. A cable with shielded cable strain relief, comprising:
at least one conductor having a separate insulation jacket;
a braided shielding layer disposed around the insulation jacket of the at least one conductor; and
an outer jacket, wherein the shielded cable strain relief includes an inner ferrule which comprises a first inner crimping member, wherein the outer jacket is removed over a length at a cable end to allow a connection of the cable to a connector assembly, wherein the first inner crimping member is crimped on and in direct contact with the braided shielding layer at the cable end adjacent to where the outer jacket ends, and wherein the braided shielding layer is folded backwards over the inner ferrule and at least a portion of the outer jacket.

2. The cable with shielded cable strain relief according to claim 1, the shielded strain relief further comprising an outer ferrule configured to be in contact with and to at least partially cover the folded braided shielding layer.

3. The cable with shielded cable strain relief according to claim 2, the outer ferrule comprising at least one outer crimping member in form of a pair of overlapping outer crimping wings.

4. The cable with shielded cable strain relief according to claim 3, wherein the overlap is dimensioned to prevent loose wires of the braided shielding layer to stick out from the outer ferrule.

5. The cable with shielded cable strain relief according to claim 1, wherein the first inner crimping member encircles the at least one conductor and comprises at least one embossment protruding inwards.

6. The cable with shielded cable strain relief according to claim 5, wherein the first inner crimping member is essentially a ring.

7. The cable with shielded cable strain relief according to claim 5, wherein the at least one embossment is designed and dimensioned to increase a contact area between the first inner crimping member and the braided shielding layer.

8. The cable with shielded cable strain relief according to claim 6, wherein the at least one embossment is formed by two parallel cuts in the ring and by inwardly pushing the portion of the ring between the cuts.

9. The cable with shielded cable strain relief according to claim 1, the inner ferrule further comprises a second inner crimping member crimped on and in contact with the outer jacket of the cable.

10. The cable with shielded cable strain relief according to claim 9, wherein the first inner crimping member is connected to the second inner crimping member.

11. The cable with shielded cable strain relief according to claim 9, wherein the second inner crimping member comprises second inner crimping wings.

12. The cable with shielded cable strain relief according to claim 1, wherein the first inner crimping member comprises first inner crimping wings.

13. The cable with shielded cable strain relief according to claim 1, wherein the outer ferrule is made of sheet metal.

14. The cable with shielded cable strain relief according to claim 1, wherein the inner ferrule is made of sheet metal.

15. The cable with shielded cable strain relief according to claim 1, wherein the cable includes two conductors, and the braided shielding layer encloses both of the conductors.

16. A method of producing a cable with a shielded cable strain relief having at least one conductor having a separate insulation jacket, a braided shielding layer disposed around the insulation jacket of the at least one conductor, and an outer jacket, wherein the shielded cable strain relief includes an inner ferrule which comprises a first inner crimping member, wherein the outer jacket is removed over a length at a cable end to allow a connection of the cable to a connector assembly, the method comprising:
rotatory stripping of the outer jacket of the cable;
crimping the inner ferule onto the cable end, the first inner crimping member being crimped on and in direct contact with the braided shielding layer of the cable;
widening the braided shielding layer; and
folding the braided shielding layer backwards over the inner ferrule.

17. The method according to claim 16, wherein the method further comprises crimping an outer ferrule over the inner ferrule and the folded braided shielding layer, the outer ferrule being in direct contact with the shielding layer.

18. The method according to claim 16, wherein the method further comprises closing first outer crimping wings in overlap when they are closed over the braided shielding layer such that wires of the shielding layer are hindered to stick out.
